(19) United States
(12) Patent Application Publication
(10) Pub. No.: US 2026/0184822 A1
(43) Pub. Date: Jul. 2, 2026

(54) PROCESS FOR THE SYNTHESIS OF SELECTIVELY ALKYLATED CYCLODEXTRINS

(71) Applicant: CYCLOLAB CYCLODEXTRIN R&D LABORATORY LTD., Budapest (HU)

(72) Inventors: Róbert IVÁNYI, Kecskemet (HU); Kata TUZA, Lajosmizse (HU); Lajos SZENTE, Budapest (HU); István PUSKÁS, Budapest (HU); Levente SZOCS, Budapest (HU); Abdula KURKAYEV, Budapest (HU)

(21) Appl. No.: 19/132,045

(22) PCT Filed: Nov. 28, 2022
(86) PCT No.: PCT/IB2022/061481

§ 371 Date: May 22, 2025

(51) Int. Cl. C08B 37/16

(52) U.S. Cl. CPC C08B 37/0012

(57) ABSTRACT

The present invention generally relates to a process for the synthesis of selectively alkylated cyclodextrins. More particularly, the present invention relates to a process of cyclodextrin alkylation in a selective manner yielding hexakis(2,6-di-O-alkyl)-alpha-cyclodextrin, heptakis(2,6-di-O-alkyl)-beta-cyclodextrin and octakis(2,6-di-O-alkyl)-gamma-cyclodextrin.

### FIELD OF THE INVENTION

The present invention generally relates to a process for the synthesis of selectively alkylated cyclodextrins. More particularly, the present invention relates to a process of partial cyclodextrin alkylation in a selective manner yielding hexakis(2,6-di-O-alkyl)-alpha-cyclodextrin, heptakis(2,6-di-O-alkyl)-beta-cyclodextrin and octakis(2,6-di-O-alkyl)-gamma-cyclodextrin.

### BACKGROUND OF THE INVENTION

Cyclodextrins (CD) are a group of cyclic oligosaccharides that are obtained from the enzymatic transformation of starch by the action of the enzyme cyclodextrin glycosyltransferase elaborated by e.g. bacterium Bacillus macerans. Various methods exist for the production of cyclodextrin glycosyltransferase as well as making and isolating the cyclodextrins. Cyclodextrins are cyclic molecules containing six to eight alpha-D-glucopyranose units linked at the 1,4 positions by alpha linkages as in amylose. As a consequence of this cyclic arrangement, the molecule is characterized as having neither a reducing end group nor a non-reducing end group. The molecule containing six alpha-D-glucopyranose units is commonly known as alpha-cyclodextrin or cyclohexaamylose, the molecule containing seven alpha-D-glucopyranose units is commonly known as beta-cyclodextrin or cycloheptaamylose and the molecule containing eight alpha-D-glucopyranose units is known as gamma-cyclodextrin or cycloctaamylose. When reference is made here to “cyclodextrin”, it is intended to include the foregoing forms of cyclodextrin as well as molecules where the number of oligomerization is over 8. As a consequence of the cyclic arrangement and the conformation of the alfa-D-glucopyranose units, there is limited free rotation about the glycosidic bonds, and the cyclodextrins exist as conical shaped molecules with the primary hydroxyls situated at the small end of the cone and the secondary hydroxyls situated at the large opening to the cone. The cavity is lined by hydrogen atoms from C3 and C5 along with the glucosidic oxygen atoms resulting in a relatively lipophilic cavity but hydrophilic outer surface. As a result of the two separate regions of different polarity and the changes in solvent structure that occur upon complexation, cyclodextrins have the ability to form inclusion complexes with a variety of organic molecules or hydrophobic moieties of macromolecules. The formation of cyclodextrin inclusion complexes with molecules is referred to as the host-guest phenomenon. These unique properties of cyclodextrins have resulted in their commercial application in agriculture, water treatment, household products and in drug delivery systems. The application of cyclodextrins in the pharmaceutical field has resulted in time release microencapsulation, improved stability, and increased aqueous solubility of various drugs.

Cyclodextrins are known generally to improve the dissolution rate of drugs. The complexes formed are, however, also stable in aqueous solution, so that the improvement in dissolution is accompanied by an increase in the saturation solubility of the drug. Unfortunately, beta-cyclodextrin that forms the most stable complexes with most drugs has the lowest water solubility, so that drugs that are complexed with it cannot be brought into solution at therapeutic concentrations. The reason for this appears to be due to the crystalline structure of beta-cyclodextrin itself.

Despite this pharmaceutical utility, cyclodextrins are not without their limitations. The use of native cyclodextrins in the clinical setting is limited to oral and topical dosage forms as the cyclodextrins exhibit nephrotoxicity upon entering the body unmetabolized. Since mammalian enzymes are specific for the degradation of linear starch molecules, the cyclodextrins remain largely unmetabolized and accumulate, due to their recirculation and re-absorption, in the proximal tubule cells.

Underivatized cyclodextrins are crystalline solids and concentration in the renal tissue is followed by crystals formation causing necrotic damage to the cells. Despite forming water soluble clathrate complexes, the crystalline cyclodextrin drug complexes have been limited in their utility to oral or sublingual administration.

### Alkylated Cyclodextrins

To overcome said disadvantages, chemical modification of cyclodextrins is known to modulate their properties. Introduction of methyl groups may lead to derivatives of highly soluble substances. Besides non-selective derivatization procedures, selective substitution patterns are favorable leading to well-characterizable, single compounds.

### Non-Selective Alkylation Reactions

The first attempt for the preparation of methylated cyclodextrins was made by Irvine, Pringsheim and MacDonald (Irvine, J. C., Pringsheim, H., MacDonald, J. Chem. Soc., 125, 942 (1924)) applying methyl sulfate as alkylating agent in sodium hydroxide solution. According to Muskat's method (Muskat, I.: J. Am. Chem. Soc., 56, 693 and 2449 (1934)) for the methylation of alpha- and beta-cyclodextrins was proceeded in liquid ammonia in the presence of metallic sodium and methyl iodide.

Ionel Ciucanu and Francisc Kerek found (Carbohydrate Research Volume 131, Issue 2, 15 Aug. 1984, Pages 209-217 “A Simple and Rapid Method for the Permethylation of Carbohydrates”) that methyl iodide was the most effective methylating agent for per-O-methylation. They applied methyl iodide in the presence of solid base (e.g. NaOH, KOH, or K-tert-BuOH/NaOH mixture) in polar aprotic solvents.

Usually regardless of the type of saccharides, permethylation is performed by alkyl halogenides (such as methyl iodide). The reaction may be performed by excellent yield (98±2%) with short reaction time (typically 6-7 minutes). The method has been first disclosed by Hakomori, therefore this methylation is also called Hakomori-methylation (S. Hakomori, J. Biochem. (Tokyo), 55 (1964) 205-208.). Hakomori used Na-hydride besides methyl iodide. The NaH base was found more favorable compared to K-tert-butoxide, which latter is safer, though does not provide adequate yield (Lindberg, Methods Enzymol., 28 (1972) 178-195. és J. Finne, T. Krusius, H. Rauvala, Carbohydr. Res., 80 (1980) 336-339.)

Similarly, fast methylation may be achieved in liquid ammonia with Na in the presence of methyl-iodide, but selectivity may not be reached, consequently the subject matter 2,6 methylation may not be achieved.

In the methylation reaction according to Brimacombe et al. NaH, methyl-iodide and/or methyl-bromide alkylation agents were used, but the solid base was used in N,N-dimethylformamide (DMF), or N-methyl-2-pyrrolidone solvent. Regioselectivity was hardly observed, the method was successfully applied to permethylated saccharides (J. S. Brimacombe, B. D. Jones M. Stacey, J. J. Willard “Alkylation of carbohydrates using sodium hydride”—Carbohydrate Research Volume 2, Issue 2, June 1966, Pages 167-169).

Partial, non-selective, random methylation of cyclodextrins is described inter alia in U.S. Pat. No. 5,710,268 (Thomas Wimmer, Consortium Für Elektrochemische Industrie GmbH, later Wacker Chemie AG). The process is based on dissolving α-, β-, or γ-cyclodextrin in a base and subsequently adding methyl chloride as an O-alkylation agent and additional base reacting cyclodextrin in the base with methyl chloride O-alkylating agent to produce a reaction mixture. Exhaustive methylation of the hexakis(6-azido)-alpha-CD (instead of native alpha-CD) was achieved in DMF by treatment with crystalline sodium hydride and methyl iodide which gave a quantitative yield of the hexakis(2,3)-di-O-methyl derivative (Boger et al. Helvetica Chimica Acta-Vol. 61, Fasc. 6, 2190 (1978)) after deprotection, but this method requires azido protective group strategy (i.e. multistep synthesis strategy) to obtain the selective methylation.

The patented technology of Cui Yanli Mao (University of Zhejiang, CN1709918, also J Chem Technol Biotechnol. 2010; 85: 248-251) describes a synthetic method resulting stochastic substitution pattern of methylated beta-cyclodextrin. The process is based on the reaction between beta-cyclodextrin, alkali metals hydroxide and methylating agent (including methyl chloride, methyl bromide and methyl iodide) under high-pressure and mixing at 60-130° C., applying the reacting pressure of 6-14 bar, and reaction time 2-9 hours.

It may be concluded therefore that alkyl halogenides are directly used for permethylation and non-selective partial alkylation of cyclodextrins.

### Selective, Partial Alkylation

For partial and selective methylation, mostly dimethyl sulfate (Me₂SO₄) and methyl carbonate have been used in the presence of appropriate base, in dipolar aprotic solvents. In the presence of strong bases (NaH, Na, liquid NH₃) the alkylation is performed rapidly, but not in a selective manner. The only known method to reach adequate selectivity is by utilizing barium-bases.

Casu et al. (Casu, B., Reggiani, M., Gallo, G. G., Vigevani, A.: Tetrahedron, 24, 803 (1968)) applied the Kuhn procedure (Kuhn, R., Trischmann, H., Low, I.: Angew. Chem., 67, 32 (1955) and Kuhn, R., Baer, H. H., Seeliger, A.: Ann., 611, 236 (1958)) for the methylation of alpha- and beta-cyclodextrins using Me₂SO₄, and BaO in a 1:1 mixture of DMF and DMSO resulting in regioselective alkylation.

Szejtli et al reported on the synthesis of heptakis(2,6-di-O-methyl)-beta-cyclodextrin using dimethyl sulfate as alkylating agent in a solution of beta-cyclodextrin prepared with 1:1 DMSO-DMF mixture containing equal amount of BaO and Ba(OH)₂·8H₂O (Szejtli, J., Lipták, A., Jodál, I., Fügedi, P., Nánási, P., Neszmélyi, A. Die Starke 32 165-169 (1980)). Later, Tanimoto et al proved that Szejtli's method is not universal for all three native cyclodextrins, methylation of gamma-CD gave mainly octakis(2,3,6-tri-O-methyl)-gamma-cyclodextrin and the partially, selectively methylated octakis(2,6-di-O-methyl)-gamma-cyclodextrin could not be detected. Szejtli's method yielded also hexakis(2,6-di-O-methyl)-mono(2,3,6-tri-O-methyl)-beta-cyclodextrin and several minor over-methylated homologues. (T. Tanimoto et al. Chem. Pharm. Bull 38(2) 318-322 (1990)).

Preparation of heptakis(2,6-di-O-methyl)-beta-cyclodextrin is described in U.S. Pat. No. 4,542,211 (Szejtli et al. Consortium für Elektrochemische Industrie GmbH, 1984) wherein the selectively methylated cyclodextrin was obtained by methylating beta cyclodextrin in an organic medium, by reacting with dimethyl sulfate in amounts of from 15 to 25 moles per 1 mole of beta-cyclodextrin in the presence of an alkali hydroxide, applied in at least an equimolar amount calculated on the amount of OH-groups to be methylated; at temperatures of from −10° to 0° C.

Boger et al prepared hexakis(2,6-di-O-methyl)-alpha cyclodextrin using alpha-cyclodextrin dissolved in DMSO and DMF. Mixture of barium hydroxide (Ba(OH)₂·8 H₂O) and carbonate-free barium oxide was applied for the methylation performed with dimethyl sulfate (Boger et al. Helvetica Chimica Acta—Vol. 61, Fasc. 6, 2190 (1978)).

According to Hungarian patent HU180580, the methylation at the 2,6 positions was performed in aqueous media in the presence of sodium hydroxide with dimethyl sulfate, repeating this step twice. The drawback of this method is that the required product could not have been prepared in a single technological step.

### BRIEF DESCRIPTION OF THE DRAWINGS

FIG. 1 shows the HPLC chromatogram of heptakis(2,6-di-O-methyl) beta cyclodextrin prepared according to Example 5

FIG. 2 depicts the NMR spectrum of heptakis(2,6-di-O-methyl) beta cyclodextrin prepared according to Example 5

FIG. 3 shows the HPLC chromatogram of heptakis(2,6-di-O-methyl) beta cyclodextrin prepared according to Example 8

FIG. 4 depicts the NMR spectrum of heptakis(2,6-di-O-methyl) beta cyclodextrin prepared according to Example 8

FIG. 5 shows the HPLC chromatogram of randomly methylated beta cyclodextrin prepared according to Example 3 compared to that of heptakis(2,6-di-O-methyl) beta cyclodextrin prepared according to Example 8.

FIG. 6 depicts the NMR spectrum of randomly methylated beta cyclodextrin prepared according to Example 3.

### DETAILED DESCRIPTION

Preferred embodiments of the disclosed process herein are provided as illustrations, and are not intended to limit the scope of this disclosure in any way. It was surprisingly found that the partial alkylation of cyclodextrins essentially yielding product substituted in all 2 and 6 positions in alpha-beta- and gamma-cyclodextrins, respectively may be achieved with a process wherein the alkylation is performed with C1-4 alkyl halogenides in the presence of barium containing catalyst. An important aspect of the invention is that the alkylation may be performed without using protective groups (i.e. one-step synthesis), in the presence of alkali metal hydroxide or alcoholate in a solvent mixture consisting essentially of water and dimethyl sulfoxide (DMSO). The performance of the reaction and selectivity using this solvent mixture was found to be superior over N,N-dimethylformamide (DMF) containing other aprotic solvent mixtures generally used in synthetic methods applied in carbohydrate chemistry.

Our invention is based on the utilization of the adequate base/catalyst combination able to differentiate according to different pK value of differently positioned hydroxyl groups in the cyclodextrin ring. The pK difference between the primary and secondary hydroxyl groups alone does not enable the discrimination between the hydroxyl groups in the 2 and 3 positions, respectively. Using BaO or Ba(OH)₂ base results in selective alkylation at the 2 and 6 positions due to complex formation of the Ba-ions and hydroxyl groups due to the consequently manifested steric hindrance. It is not known in the art that the presence of DMF is detrimental for this selectivity and its presence lowers the yield of the selectively substituted 2,6-alkylated species. It is anticipated that the typical impurity dimethylamine (DMA) and formic acid present in DMF evolves due to both acids and bases and especially upon alkylating reactions (Liu, J et al. Journal of Molecular Structure Vol. 654, Issues 1-3, 215-221 and Burrows, A. et al Cryst Eng Comm, 2005, 7(89), 548-550). The presence of DMA is unfavorable in the pharmaceutical application of the subject matter selectively alkylated cyclodextrins since DMA may undergo nitrosation under weak acid conditions to give dimethylnitrosamine, which is a known carcinogen (Questions and answers on “Information on nitrosamines for marketing authorization holders EMA/CHMP/428592/2019 Rev. 1). Control of nitrosamines in selectively alkylated cyclodextrins was followed by adaptation of FDA limit test (https://www.fda.gov/media/124025/download) according to Example 1. The method enables the quantitation of nitrosamines at the level of 0.05 ppm.

DMA in the selectively alkylated cyclodextrins was determined by a GC-headspace chromatography method adapted for this compound (A. R. Deshpande et al. Eurasian J Anal Chem 2012; 7(1):43-48).

It was also surprisingly found that amongst the suitable methyl halogenides, methyl iodide could effectively reduce the freeze point temperature of DMSO to the temperature range (below +5° C.) where the selectivity enhancement of Ba-ions is manifested.

It was further surprisingly found that the increased yield according to present invention enables the isolation of the selectively alkylated cyclodextrin without the need of hot recrystallization—which is a technologically unfavorable additional step in the earlier disclosed processes (e.g., the crude product synthesized from dimethyl sulfate in mixture of DMF and/or DMSO according to Examples 5-6.)—utilizing only solvent-based precipitation.

The barium content of the crude reaction mixture was reduced by extraction with dichloromethane and acetic acid which are added to the mixture applying reduced temperature. Two immiscible phases are formed and the organic layer is washed several times with water and sodium hydrogen carbonate solution. The obtained organic layer is concentrated in vacuo. The product is precipitated from the concentrated solution by addition of diisopropyl ether.

Further advantage of the process according to present invention is that the resulting product contains low amount of residual impurities (i.e. barium catalyst and residual alkylating agent) due to the suitable selection of precipitating solvents. Barium level is maximized in 30 ppm related to the most critical pharmaceutical products as referenced in document ICH guideline Q3 page 26 (28 Mar. 2019).

### Example 1

Nitrosamine Impurity Assay by GC-MS/MS
Instrument and Equipment
Gas Chromatography System with a Quadrupole Mass Spectrometry Detector and Headspace Auto-sampler
DB-Wax GC Column, 30 m×0.25 mm, 0.5 μm, or equivalent
Analytical Balance
Wrist Action Mechanical Shaker
Vortex Mixer
20 mL Headspace Vials
HS vial caps with Teflon/Silicone septa
Solvent
Dimethyl sulfoxide (DMSO), >99.5%
Standard Stock Solutions
   N-nitrosodimethylamine (NDMA): 1 mg/mL in MeOH
   N-nitrosodimethylamine-d6 labeled (NDMA d6): 1 mg/mL in MeOH

### Standards Preparation

### Internal Standard Solution (NDMA d6):

To 100 mL volumetric flask containing approximately 90 mL DMSO, transfer 1 mL NDMA-d6 standard stock solution (1 mg/mL) utilizing a 1000 μL pipettor.

Make up the volume to 100 mL with DMSO and mix well to get 10 μg/mL concentration.

### Sample Preparation for Cyclodextrin

Accurately weigh 500 mg of test cyclodextrin into a 20 mL headspace vial. Add 4.5 mL of DMSO and 0.5 mL of internal standard solution to the vial and immediately cap and crimp the vial. Mix the sample solution using a vortex mixer.
GC/MS—HS Parameters Instrument: Agilent 7890B GC with Agilent 5977A MSD and Agilent 7697A HS Auto-sampler
Column: DB-WAX, 30 m×0.25 mm, 0.5 μm
Inlet Temperature: 220° C.
Column Flow: 1 mL/min
Split Ratio 5:1
Oven Program: 70° C. for 4 min.; 20° C./min to 240° C., Hold for 3.5 min. GC Run Time 16 min.
GC Cycle Time: 24 min.
HS Auto-sampler Parameters Oven Temperature: 120° C.
Loop Temperature: 125° C. Transfer Line Temperature: 130° C.
Vial Equilibration Time: 15 min Injection Time: 1.0 min Vial Size: 20 mL Vial
Shaking: Level 9 (250 shakes/min) Fill Pressure: 15 psi Loop Size: 1 mL
MS Parameters MS Source Temperature: 230° C. Quad Temperature: 150° C.
Acquisition Type: SIM Gain Factor 5 Solvent Delay: 6.0 min.

### Example 2

### HPLC Analysis of Alkylated Cyclodextrin Derivatives

### Apparatus:

Agilent 1260 Quaterner Pumping System
Agilent 1100 Series Thermostatted Column Compartment
Agilent two way/six-port switch valve
Agilent 1260 Series Thermostatted Autosampler
Agilent 1200 DAD detector
Agilent 1260 Refractive index detector
Agilent OpenLAB CDS ChemStation Rev. C.01.07 SR3

Column: Kinetex C18 (Phenomenex) In house code: KIN1 (Batch No.: 5569-110) and KIN7 (Batch No.: 5569-0217).
Column length: 100 mm
Inner diameter: 4.6 mm
Particle size: 2.6 μm

Guard: SecurityGuard Cartridge C18 4×3.0 mm ID (Phenomenex).
Column temperature: 30° C.
Mobile phase:

| | |
|---|---|
| Isopropanol (IPA) | 70 mL |
| Methanol | 410 mL |
| Water | 520 mL |

Flow: 0.5 mL/min.
RI detector temperature: 40° C.
Sample volume: 10 μl
Sample concentration: 8 mg/mL
Stop time: 45 min.
Integrator: Area

### Example 3

Preparation of Methyl-ß-Cyclodextrin with Methyl Iodide (Random Alkylation)

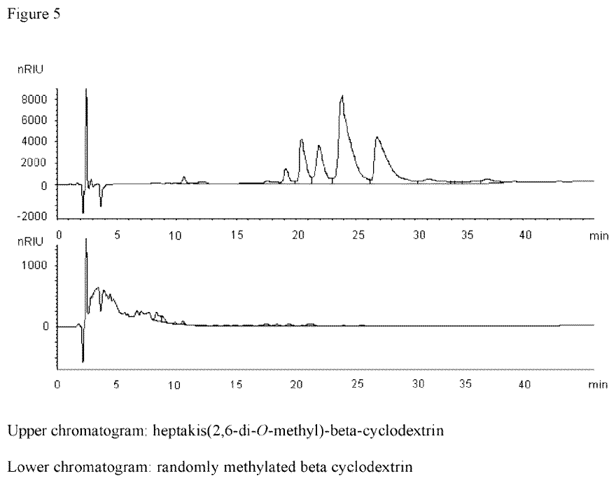

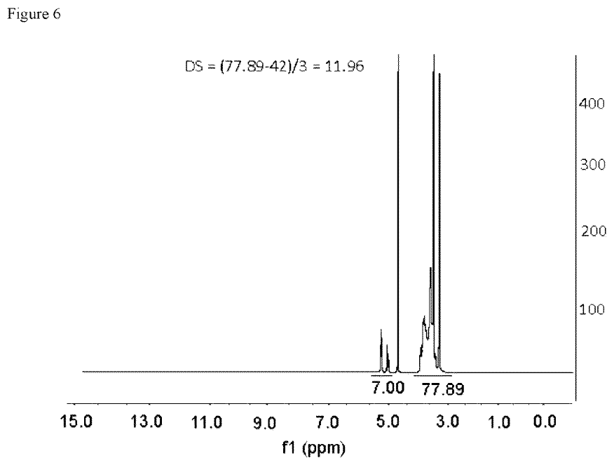

113.5 g (0.1 mol) ß-cyclodextrin is dissolved in 800 mL dimethyl sulfoxide. 280 mL (4.5 mol) methyl iodide is added to the reaction mixture under stirring at room temperature. 123 g (3.08 mol) Sodium hydroxide is dissolved in 113 mL water. The sodium hydroxide solution is added dropwise to the reaction mixture under stirring during a course of 3 hours at a stable rate while maintaining the temperature below 30° C. The desired degree of substitution is achieved by stirring the reaction mixture at room temperature for approximately an additional 2 hours after the addition of the sodium hydroxide solution. The mixture is diluted with sodium chloride solution 30 minutes later and extracted with ethyl acetate. The organic layer is washed several times with sodium chloride solution and sodium sulfate solution, then dried with anhydrous sodium sulfate. The obtained solution is dried in vacuo. FIG. 5 depicts the chromatogram of the obtained product in comparison with that of a selectively alkylated analogue: heptakis(2,6-di-O-methyl)-beta-cyclodextrin. FIG. 6 depicts the NMR spectrum.
Obtained white, amorphous product: 118.5 g
Residual solvent: 1.0 (m/m) %
Heptakis(2,6-di-O-methyl)-β-cyclodextrin content not detected

### Example 4

Preparation of Methyl-ß-Cyclodextrin with Methyl Bromide (Random Alkylation)

113.5 g (0.1 mol) ß-cyclodextrin is dissolved in 800 mL 50-50 vol % solvent mixture of DMF and DMSO. The solution is cooled down to −2° C. and 248 mL (4.5 mol) methyl bromide (b.p. +4° C.) is added to the reaction mixture under stirring. 123 g (3.08 mol) sodium hydroxide is dissolved in 113 mL water. The sodium hydroxide solution is added dropwise to the reaction mixture under stirring during a course of 3 hours at a stable rate while maintaining the temperature at −2° C. The desired degree of substitution is achieved by stirring the reaction mixture at −2° C. for approximately an additional 2 hours after the addition of the sodium hydroxide solution. Water is added to the mixture and it is heated to 5° C. in order to hydrolyze the unreacted methyl bromide. The mixture is diluted with sodium chloride solution 30 minutes later and extracted with ethyl acetate. The organic layer is washed several times with sodium chloride solution and sodium sulfate solution, then dried with anhydrous sodium sulfate. The obtained solution is dried in vacuo.
Obtained white, amorphous product: 117.0 g
Residual solvent: 1.5 (m/m) %
Heptakis(2,6-di-O-methyl)-β-cyclodextrin content not detected
N-nitrosodimethylamine content 1.3 ppm
DMA content 0.8 ppm

### Example 5

Preparation of Heptakis(2,6-Di-O-Methyl)-ß-Cyclodextrin with Dimethyl Sulfate (I)

113.5 g (0.1 mol) ß-cyclodextrin is dissolved in 800 mL DMSO. 333 mL (3.5 mol) dimethyl sulfate is added to the solution and it is cooled down to −2° C. After reaching the prescribed temperature 110 g (0.35 mol) Barium hydroxide octahydrate is added to the reaction mixture under stirring. The stirring is continued for 1 hour at −2° C. until a clear solution is obtained. 126 g (3.15 mol) sodium hydroxide is dissolved in 113 mL water. The sodium hydroxide solution is added dropwise to the reaction mixture under stirring during a course of 3 hours at a stable rate while maintaining the temperature at −2° C. The desired degree of substitution is achieved by stirring the reaction mixture at −2° C. for approximately an additional 2 hours after the addition of the sodium hydroxide solution. Water is added to the mixture and it is heated to 20° C. in order to hydrolyze the unreacted dimethyl sulfate. The mixture is diluted with sodium chloride solution 30 minutes later and extracted with ethyl acetate. The organic layer is washed several times with sodium chloride solution and sodium sulfate solution, then dried with anhydrous sodium sulfate. The obtained solution is concentrated in vacuo. The product is obtained from the concentrated solution by addition of diisopropyl ether and n-hexane. The resulting solid is dried.
Obtained white, crystalline product: 118.5 g
Residual solvent: 1 (m/m) %

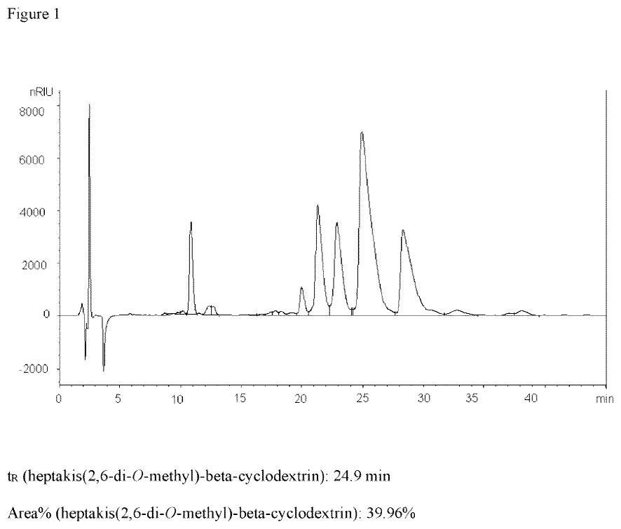

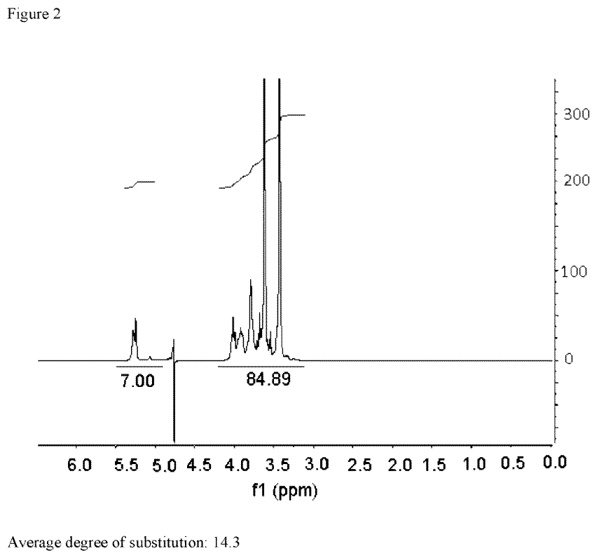

In order to reduce the residual solvent content, the 118.5 g heptakis(2,6-di-O-methyl)-β-cyclodextrin is first dissolved in cold water and then heated to 90° C. under stirring. The pure product crystallizes from the mixture upon heating; it is filtered at 90° C. and then dried. HPLC chromatogram of the substance is shown in FIG. 1., the corresponding NMR spectrum is depicted in FIG. 2.
Obtained white, crystalline heptakis(2,6-di-O-methyl)-β-cyclodextrin: 82.5 g
Yield: 62%
Barium content (ICP-MS): 150 ppm
Residual dimethyl sulfate content (GC-MS): 20 ppm

### Example 6

Preparation of Heptakis(2,6-Di-O-Methyl)-ß-Cyclodextrin with Dimethyl Sulfate (II)

113.5 g (0.1 mol) ß-cyclodextrin is dissolved in 800 mL 50-50 vol % solvent mixture of DMF and DMSO. 333 mL (3.5 mol) dimethyl sulfate is added to the solution and it is cooled down to −2° C. After reaching the prescribed temperature 110 g (0.35 mol) barium hydroxide octahydrate is added to the reaction mixture under stirring. The stirring is continued for 1 hour at −2° C. until a clear solution is obtained. 126 g (3.15 mol) sodium hydroxide is dissolved in 113 mL water. The sodium hydroxide solution is added dropwise to the reaction mixture under stirring during a course of 3 hours at a stable rate while maintaining the temperature at −2° C. The desired degree of substitution is achieved by stirring the reaction mixture at −2° C. for approximately an additional 2 hours after the addition of the sodium hydroxide solution. Water is added to the mixture and it is heated to 20° C. in order to hydrolyze the unreacted dimethyl sulfate. The mixture is diluted with sodium chloride solution 30 minutes later and extracted with ethyl acetate. The organic layer is washed several times with sodium chloride solution and sodium sulfate solution, then dried with anhydrous sodium sulfate. The obtained solution is concentrated in vacuo. The product is obtained from the concentrated solution by addition of diisopropyl ether and n-hexane.
Obtained white, crystalline product: 118.5 g
Residual solvent: 1 (m/m) %

In order to reduce the residual solvent content, the 118.5 g heptakis(2,6-di-O-methyl)-β-cyclodextrin is first dissolved in cold water and then heated to 90° C. under stirring. The pure product crystallizes from the mixture upon heating; it is filtered at 90° C. and then dried.
Obtained white, crystalline Heptakis(2,6-di-O-methyl)-β-cyclodextrin: 82.5 g
Yield: 62%
Barium content (ICP-MS): 160 ppm
Residual dimethyl sulfate content (GC-MS): 25 ppm
N-nitrosodimethylamine content 1.4 ppm
DMA content 0.9 ppm

### Example 7

Preparation of Hexakis(2,6-Di-O-Methyl)-α-Cyclodextrin with Methyl Bromide

136.2 g (0.14 mol) α-cyclodextrin is dissolved in 925 mL DMSO. 304 mL (5.51 mol) methyl bromide with a temperature of −20° C. is added to the solution in a manner that the resulting mixture acquires a temperature of −6° C. After reaching the prescribed temperature 265.0 g (0.84 mol) barium hydroxide octahydrate is added in several portions to the reaction mixture under stirring. 152.4 g (3.81 mol) sodium hydroxide is dissolved in 194 mL water. The sodium hydroxide solution is added dropwise to the reaction mixture under stirring during a course of 1 hour at a stable rate while maintaining the temperature at −4° C. After the addition the reaction mixture is stirred at −4° C. for 1 hour. 250 mL tetrahydrofuran is added to the mixture. The stirring is continued at −4° C. for 5.5 hours. The reaction mixture is heated to 5° C. within 30 minutes. 610 mL water is added to the mixture and the stirring is continued for 10 minutes at 5° C. 820 mL dichloromethane is added to the mixture. 360 mL acetic acid is added. The two phases are separated and the organic layer is washed several times with water and sodium hydrogen carbonate solution. The obtained organic layer is concentrated in vacuo. The product is precipitated from the concentrated solution by addition of diisopropyl ether. The resulting product is recrystallized from water and dried.
Obtained white, crystalline hexakis(2,6-di-O-methyl)-α-cyclodextrin: 139.0 g
Yield: 87%
Barium content (ICP-MS): 5 ppm
Residual methyl bromide content (GC-MS): 0.9 ppm
N-nitrosodimethylamine content <0.05 ppm
DMA content <0.03 ppm

### Example 8

Preparation of Heptakis(2,6-Di-O-Methyl)-ß-Cyclodextrin with Methyl Iodide

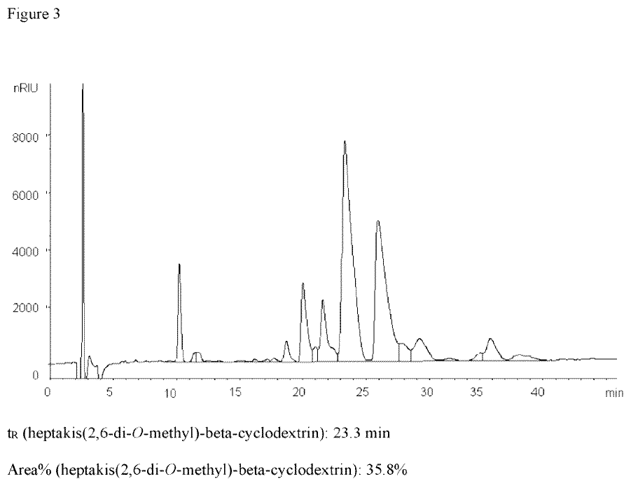

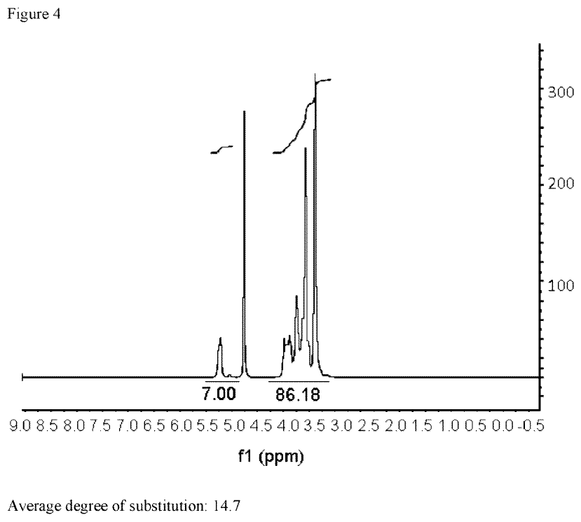

158.9 g (0.14 mol) β-cyclodextrin is dissolved in 925 mL DMSO. 400 mL (6.43 mol) methyl iodide is added to the solution at 15° C. and it is cooled down to −6° C. After reaching the prescribed temperature 309.5 g (0.98 mol) barium hydroxide octahydrate is added in several portions to the reaction mixture under stirring. 178 g (4.45 mol) sodium hydroxide is dissolved in 194 mL water. The sodium hydroxide solution is added dropwise to the reaction mixture under stirring during a course of 1 hour at a stable rate while maintaining the temperature at −4° C. After the addition the reaction mixture is heated to 3° C. within 30 minutes and stirred at 5° C. for 1 hour. 250 mL tetrahydrofuran is added to the mixture. The stirring is continued at 5° C. for 5.5 hours. The reaction mixture is heated to 20° C. within 30 minutes. 610 mL water is added to the mixture and the stirring is continued for 10 minutes at 20° C. 820 mL Dichloromethane is added to the mixture and then it is cooled down to 10° C. 360 mL acetic acid is added. The two phases are separated and the organic layer is washed several times with water and sodium hydrogen carbonate solution. The obtained organic layer is concentrated in vacuo. The product is precipitated from the concentrated solution by addition of diisopropyl ether. The resulting product is recrystallized from water and dried. HPLC chromatogram of the substance is shown in FIG. 3., the corresponding NMR spectrum is depicted in FIG. 4.
Obtained white, crystalline heptakis(2,6-di-O-methyl)-β-cyclodextrin: 162.1 g
Yield: 87%
Barium content (ICP-MS): 4 ppm
Residual methyl iodide content (GC-MS): 0.9 ppm
N-nitrosodimethylamine content <0.05 ppm
DMA content <0.03 ppm

### Example 9

Preparation of Octakis(2,6-Di-O-Methyl)-γ-Cyclodextrin with Methyl Iodide

181.6 g (0.14 mol) 7-cyclodextrin is dissolved in 925 mL DMSO Dimethyl sulfoxide. 457 mL (7.34 mol) Methyl iodide is added to the solution at 15° C. and it is cooled down to −6° C. After reaching the prescribed temperature 353.3 g (1.12 mol) barium hydroxide octahydrate is added in several portions to the reaction mixture under stirring. 203.2 g (5.08 mol) sodium hydroxide is dissolved in 194 mL water. The sodium hydroxide solution is added dropwise to the reaction mixture under stirring during a course of 1 hour at a stable rate while maintaining the temperature at −4° C. After the addition the reaction mixture is heated to 3° C. within 30 minutes and stirred at 5° C. for 1 hour. 250 mL tetrahydrofuran is added to the mixture. The stirring is continued at 5° C. for 5.5 hours. The reaction mixture is heated to 20° C. within 30 minutes. 610 mL Water is added to the mixture and the stirring is continued for 10 minutes at 20° C. 820 mL Dichloromethane is added to the mixture and then it is cooled down to 10° C. 360 mL acetic acid is added. The two phases are separated and the organic layer is washed several times with water and sodium hydrogen carbonate solution. The obtained organic layer is concentrated in vacuo. The product is precipitated from the concentrated solution by addition of diisopropyl ether. The resulting product is recrystallized from water and dried.
Obtained white, crystalline octakis(2,6-di-O-methyl)-γ-cyclodextrin: 185.3 g
Yield: 87%
Barium content (ICP-MS): 3 ppm
Residual methyl iodide content (GC-MS): 0.8 ppm
N-nitrosodimethylamine content <0.05 ppm
DMA content <0.03 ppm

### Example 10

Preparation of Hexakis(2,6-Di-O-n-Butyl)-α-Cyclodextrin with n-Butyl Iodide

136.2 g (0.14 mol) α-cyclodextrin is dissolved in 925 mL DMSO. 640 mL (5.62 mol) n-butyl iodide is added to the solution at 15° C. and it is cooled down to −6° C. After reaching the prescribed temperature 265.3 g (0.84 mol) barium hydroxide octahydrate is added in several portions to the reaction mixture under stirring. 152.6 g (3.82 mol) sodium hydroxide is dissolved in 194 mL water. The sodium hydroxide solution is added dropwise to the reaction mixture under stirring during a course of 1 hour at a stable rate while maintaining the temperature at −4° C. After the addition the reaction mixture is heated to 3° C. within 30 minutes and stirred at 5° C. for 1 hour. 250 mL tetrahydrofuran is added to the mixture. The stirring is continued at 5° C. for 5.5 hours. The reaction mixture is heated to 20° C. within 30 minutes. 610 mL water is added to the mixture and the stirring is continued for 10 minutes at 20° C. 820 mL Dichloromethane is added to the mixture and then it is cooled down to 10° C. 360 mL acetic acid is added. The two phases are separated and the organic layer is washed several times with water and sodium hydrogen carbonate solution. The obtained organic layer is concentrated in vacuo. The product is precipitated from the concentrated solution by addition of diisopropyl ether. The resulting product is dried.
Obtained white, crystalline hexakis(2,6-di-O-n-butyl)-α-cyclodextrin: 0.125 mol
Yield: 89%
Barium content (ICP-MS): 4 ppm
Residual n-butyl iodide content (GC-MS): 0.9 ppm
N-nitrosodimethylamine content <0.05 ppm
DMA content <0.03 ppm

### Example 11

Preparation of Hexakis(2,6-Di-O-t-Butyl)-α-Cyclodextrin with t-Butyl Chloride

136.2 g (0.14 mol) α-cyclodextrin is dissolved in 925 mL DMSO. 598 mL (5.49 mol) t-butyl chloride (b.p. +51° C.) is added to the solution at 15° C. and it is cooled down to −6° C. After reaching the prescribed temperature 265.3 g (0.84 mol) barium hydroxide octahydrate is added in several portions to the reaction mixture under stirring. 152.6 g (3.81 mol) sodium hydroxide is dissolved in 194 ml water. The sodium hydroxide solution is added dropwise to the reaction mixture under stirring during a course of 1 hour at a stable rate while maintaining the temperature at −4° C. After the addition the reaction mixture is heated to 3° C. within 30 minutes and stirred at 5° C. for 1 hour. 250 mL tetrahydrofuran is added to the mixture. The stirring is continued at 5° C. for 5.5 hours. The reaction mixture is heated to 20° C. within 30 minutes. 610 mL water is added to the mixture and the stirring is continued for 10 minutes at 20° C. 820 mL dichloromethane is added to the mixture and then it is cooled down to 10° C. 360 mL acetic acid is added. The two phases are separated and the organic layer is washed several times with water and sodium hydrogen carbonate solution. The obtained organic layer is concentrated in vacuo. The product is precipitated from the concentrated solution by addition of diisopropyl ether. The resulting product is dried.
Obtained white, crystalline hexakis(2,6-di-O-t-butyl)-α-cyclodextrin: 0.122 mol
Yield: 87%
Barium content (ICP-MS): 5 ppm
Residual t-butyl chloride content (GC-MS): 0.9 ppm
N-nitrosodimethylamine content <0.05 ppm
DMA content <0.03 ppm

What is claimed is:

1. Process for selective partial alkylation in the 2 and 6 positions of cyclodextrins performed with C1-4 alkyl halogenides in a single step.

2. The process according to claim 1 characterized in that the alkylation is performed in the presence of barium containing catalyst.

3. The process according to any of the claims 1-2 characterized in that alkali metal hydroxide or alcoholate is applied as a base.

4. The process according to any of the claims 1-3 characterized in that the reaction solvent comprises more than 50% dimethyl sulfoxide.

5. The process according to any of the claims 1-4 characterized in that the selective alkylation of cyclodextrins is performed with alkyl iodide.

6. The process according to any of the claims 1-4 characterized in that the selective alkylation of cyclodextrins is performed with methyl halogenide.

7. The process according to any of the claims 1-5 characterized in that the used Barium containing catalyst is Barium oxide or Barium-hydroxide.

8. The process according any of the claims 1-6 characterized in that the product is isolated by precipitation with a suitable organic solvent.

9. 2,6-di-O-alkylated cyclodextrins characterized in that the product contains less than 1 ppm nitrosamine impurity.

10. 2,6-di-O-alkylated cyclodextrins according to claim 9 characterized in that the product contains less than 0.5 ppm nitrosamine impurity.

11. 2,6-di-O-alkylated cyclodextrins according to claim 8 characterized in that the product contains less than 0.1 ppm nitrosamine impurity.

12. 2,6-di-O-alkylated cyclodextrins characterized in that the product contains less than 100 ppm alkyl halogenide impurity.

13. 2,6-di-O-alkylated cyclodextrins according to claim 11 characterized in that the product contains less than 50 ppm alkyl halogenide impurity.

14. 2,6-di-O-alkylated cyclodextrins according to claim 11 characterized in that the product contains less than 10 ppm alkyl halogenide impurity.

15. 2,6-di-O-alkylated cyclodextrins characterized in that the product contains less than 30 ppm barium.

16. 2,6-di-O-alkylated cyclodextrins according to claim 11 characterized in that the product contains less than 20 ppm barium.

17. 2,6-di-O-alkylated cyclodextrins according to claim 11 characterized in that the product contains less than 10 ppm barium.
